(19) United States
(12) Patent Application Publication
(10) Pub. No.: US 2012/0072189 A1
(43) Pub. Date: Mar. 22, 2012

(54) SENSOR SYSTEMS FOR ESTIMATING FIELD

(75) Inventors: Robert Jon BULLEN, Dumoril (FR); Felicity Meriel DORMON, Filton (GB); Alexander John MITCHELL, Guilford (GB)

(73) Assignee: BAE SYSTEMS plc

(21) Appl. No.: 13/179,011

(22) Filed: Jul. 8, 2011

Related U.S. Application Data
(63) Continuation of application No. 12/953,008, filed on Nov. 23, 2010, now abandoned.
Application No. 12/953,008 is a continuation of application No. 12/754,239, filed on Apr. 5, 2010, now abandoned.
Application No. 12/754,239 is a continuation of application No. 12/307,074, now abandoned.

(30) Foreign Application Priority Data
Jun. 30, 2006 (EP) 06253460.7
Jun. 30, 2006 (GB) 0613059.5

(51) Int. Cl. G06F 17/10

(52) U.S. Cl. 703/2

(57) ABSTRACT

In a sparse sensor array for detecting the progression of a cloud of gas within a confined space, a method is disclosed for estimating a distribution of the cloud of gas throughout the confined space. The method includes determining at each interval a plurality of functions representing possible distributions of the gas cloud by a Gaussian process, employing a particle filtering process to predict the progression of each such function at a subsequent sampling instant, using a diffusion equation for the gas cloud, attaching a likelihood value to each function at the subsequent sampling instant, and determining a revised set of functions with associated likelihood values, and repeating the above steps.

### FIELD OF THE INVENTION

The invention relates to a sensor array, and to an improved method and apparatus incorporating such a sensor array for detecting and estimating an item of interest, as represented by a field, for example a cloud of gas.

### BACKGROUND OF THE INVENTION

There are many situations of interest where it is desirable to track a variable, which is represented as a field having spatial dimensions, and which o progresses over a period of time. For example, gas may be released within an enclosed or confined space, and it is important to track the development of the gas cloud and to estimate and to forecast its progress and concentration.

In the case where a very large number of sensors is provided within the enclosed space of interest, a gas cloud may be tracked simply from direct readings of gas concentration at each sensor. However where only a few sensors can be provided for example for reasons of expense, and the enclosed space is of a complex shape, then it is necessary to estimate from just a few sensor readings the concentration and progression of a gas cloud.

### SUMMARY OF THE INVENTION

The present invention is based on the concept of providing a limited number of sensors within a space to be monitored and to provide a means of estimating from sensor readings progression of a variable of interest that may be described by a field, employing a Gaussian process mechanism together with a filtering mechanism for regularly updating the estimates obtained by means of the Gaussian process.

A problem with estimation of complex variables such as progression of a gas cloud is that they are non-Gaussian in nature. Hence well-known statistical mechanisms for estimation which are based on a Gaussian distribution are not suitable.

A Gaussian process describes a set of functions: each sample from the distribution is itself a function. A Gaussian process may be regarded as a collection of random variables, any finite subset of which has a joint Gaussian distribution. More rigorous mathematical definitions of Gaussian processes are given at http:\\www.Gaussianprocess.org.

In accordance with the invention, readings are taken from sensors and a plurality (N) of possible distribution functions are estimated from these readings. Such distribution functions may be denoted as “surfaces”.

In accordance with the invention, a recursive technique is employed to improve upon the initial estimate of N surfaces. Since these surfaces may well be non-Gaussian, and non-analytic and of any random nature, techniques such as Kalman filtering which assume Gaussian distributions would not be suitable.

Whilst techniques such as ensemble Kalman filters may be appropriate in some circumstances, it is preferred in accordance with the invention to employ a particle filtering process to improve the estimate. This makes no assumptions as to the form of the distribution, but uses a system model, for example an analytic equation for predicting the propagation or progress of the variable.

The particle filtering technique is known, see Arulampalam, IEEE Transactions on Signal Processing Vol. 50, No. 2, February 2002, pp 174188 “A Tutorial on Particle Filters for Online Nonlinear/Non-Gaussian Bayesian Tracking”.

A standard particle filter algorithm may be summarised as including the following key steps (see FIG. 7(a)):

1. A set of particles is maintained that is candidate representatives of a system state. A weight is assigned to each particle, and an estimate of the state is obtained by the weighted sum of the particles (a non-analytic probability distribution function (pdf)).

2. A recursive operation is carried out that has two phases: prediction and update.

3. For prediction, at time t=k, the pdf is known at the previous time instant t=k−1. A system model is used to predict the state at time t=k.

4. For update, at time t=k, a measurement of the system becomes available, which is used to update the pdf that was calculated in the prediction phase. During update, the particles may be resampled to remove particles with small weight.

5. Return to step 3. above.

In the present invention “particles” comprise the distribution surfaces representing for example a gas cloud concentration. Over a period of time with repeated samplings from the sensor readings, the candidate particles or surfaces are discriminated and an aim is to provide an estimate with a high probability of representing the actual distribution.

The invention provides for a specific case where it may be necessary to continuously monitor the progression of a gas cloud by an operator. The operator will need to know at any given instant what the likely concentration and distribution is. In order to represent this in accordance with the invention the weighted particle set obtained from the particle filtering process provides a weighted average field, which is displayed to the operator for giving the operator the “best-guess” at any particular instant.

Thus the invention, at least in a preferred form, may be summarised as including the following steps:
A sample of (in the preferred instance, gas concentration) values is taken from sparsely located sensors.
A Gaussian process is then used to generate a distribution over functions that explains the set of sampled values.
Sample functions from this distribution are taken and propagated forward using a generic, physical propagation model. Each of these surfaces is a particle in a particle filter, a method of discretely sampling through time a probability distribution.
In addition to the next reading from the sensors, additional synthetic point values are generated from the various propagated functions, weighted by their probability given the sensed values (i.e. how close the propagated functions come to the next set of samples).
A new Gaussian process is created using the new sensed values and the synthetic extra points. This is used to generate a new distribution over functions and the process is repeated.
The statistical element of this invention compensates for unknowns like the complete physics of the domain.

Although a preferred application of the invention is for sensing the development of a gas cloud, the present invention may have other applications such as monitoring the position of discrete objects, where such objects may be represented for example by a field expressing its probability of occurrence at any location.

Accordingly, in a first aspect, the invention provides a sensor array for detecting and estimating the progression of an item of interest, the sensor array comprising: a plurality of sensors, means for determining sensor readings at predetermined intervals, Gaussian process means for determining at each interval a plurality of functions representing possible distributions of the item of interest, system model means for predicting the value of each such function at a subsequent sampling instant, and filter means for determining a likelihood value for each said function at the subsequent sampling instant; and for determining a revised plurality of functions with associated likelihood values.

In a second aspect, the invention provides, in a sensor array for detecting and estimating the progression of an item of interest, the sensor array comprising a plurality of sensors and means for determining sensor reading at predetermined intervals, a method for estimating a distribution function for an item of interest, the method comprising the steps of: determining at each interval a plurality of functions representing possible distributions of the item of interest by means of a Gaussian process, predicting the progression of each such function at a subsequent sampling instant, using a system model for the item of interest, determining a likelihood value for each function at the subsequent sampling instant, and determining a revised set of functions with associated likelihood values, and repeating said predicting and determining steps.

It is to be appreciated that the invention also resides in a computer program comprising program code means for performing the method steps described hereinabove when the program is run on a computer.

Furthermore, the invention also resides in a computer program product comprising program code means stored on a computer readable medium for performing the method steps described hereinabove when the program is on a computer.

### BRIEF DESCRIPTION OF THE DRAWINGS

A preferred embodiment of the invention will now be described with reference to the accompanying drawings wherein;

FIG. 1 shows the invention in conceptual form;

FIG. 2 shows the process embodying the invention in a conceptual diagrammatic way;

FIGS. 3 to 5 shows the process embodying the invention in a more detailed way;

FIG. 6 indicates diagrammatically essential steps in a particle filtering process embodying the invention; and

FIG. 7 draws a comparison between the process embodying the invention and a standard particle filtering process.

### DESCRIPTION OF THE PREFERRED EMBODIMENT

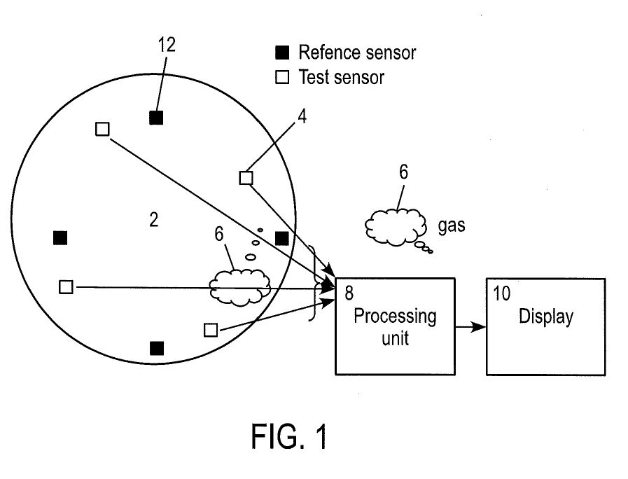

Referring to FIG. 1, an enclosed or confined space 2 is indicated conceptually. An array of sensors 4, in this case comprising four sensors, is arranged to detect the presence and concentration of a gas cloud 6 of a specified substance. The sensors provide outputs to a signal processing and computing unit 8. A display unit 10 is provided for use by an operator. In addition an array of reference sensors 12 is provided for calibrating the sensors 4. Sensor readings are taken from the sensors at periodic intervals to monitor the presence and concentration of a gas, which may be moving, by diffusion, convection, etc, across space 2. Since only four sensors are provided and the enclosed space may in practice be large and of a complex shape, the present s invention estimates from these sparsely situated sensors, the distribution of the gas cloud at other points within space 2 by means of the following steps:

1. An initial sample is taken from the sensors.

2. A series of generating functions is hypothesised, resulting in possible concentration distributions.

3. Future functions/distributions are predicted with a generic system process model.

4. Likelihood of predicted/propagated future functions/distributions are re-assessed in view of sensor readings at the next time interval.

5. A sample of points is generated from each generating function, weighted by likelihood as calculated in step 4.

6. New functions are generated from sensor and sample points.

7. Return to step 3. above and continue iterations for as long as appropriate.

The aim is to provide after a series of iterations an estimate that has a high likelihood of representing the actual gas concentration and distribution.

If at any particular instance, an operator monitoring the process needs to make an assessment of the likely distribution of the gas cloud, then a weighted average of the most likely generating functions is provided to the operator as representing the best guess at that particular instance.

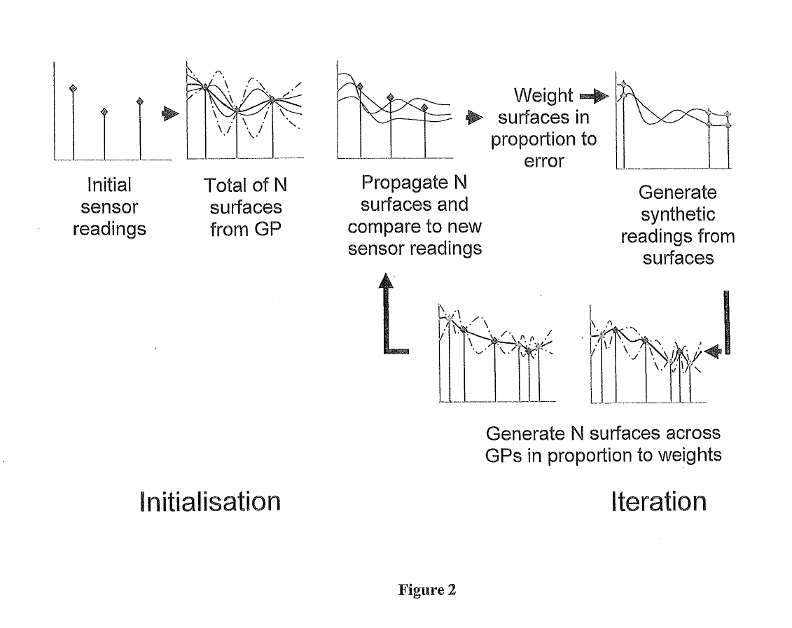

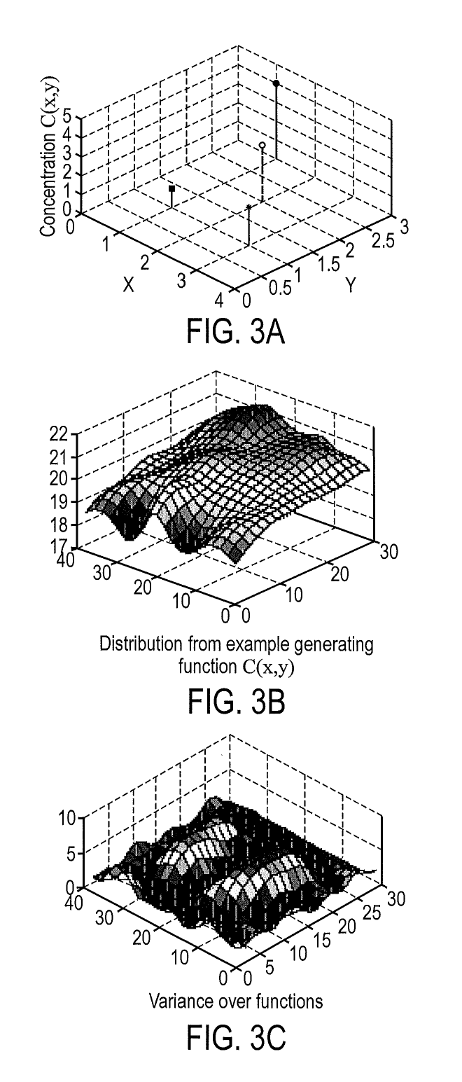

The above steps are summarised in FIG. 2, where GP denotes Gaussian Process. The process of FIG. 2 is shown in more detail in FIGS. 3 to 5 and FIG. 7(b).

Referring to FIG. 3a, in an initial step, samples from four sensors provide instantaneous point concentrations at those sensor positions. In FIG. 3b, possible generating functions are computed using a Gaussian process. There is a distribution of possible generating functions, and an example distribution is shown in FIG. 3b. Each generating function represents concentration at any particular point within the enclosed space, and the collection of points provides a “surface”.

In FIG. 3c, at any specific point each generating function will have a specific value, and the degree of uncertainty in that value is represented by a variance value, one principal factor affecting the variance value being how close the point is to a sensor.

According to the Gaussian process, at any particular point, the range of values of different functions is Gaussian in nature.

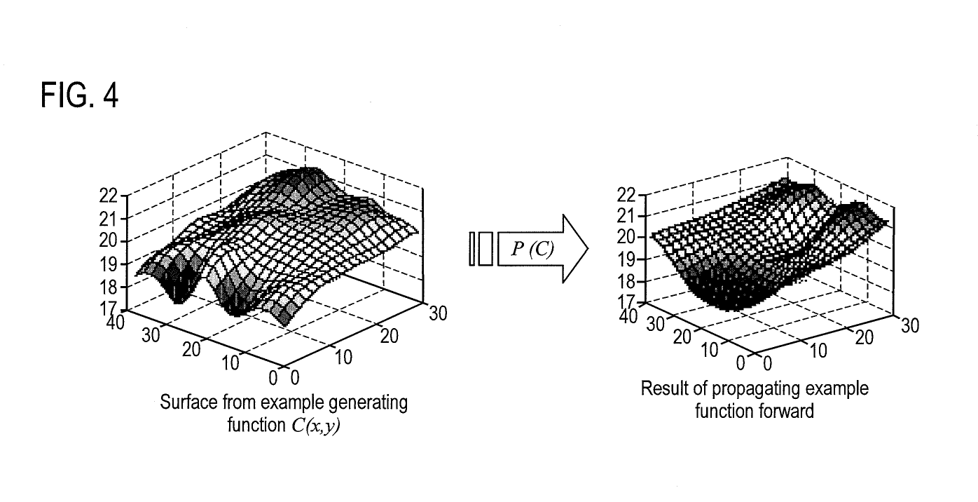

FIG. 4 shows an example generating function. Such function will account for data with probability according to its position within the distribution or spectrum of all generating functions. In accordance with the particle filtering process, this example function is sampled according to its probability or likelihood of being the actual distribution. A prediction stage then occurs in the particle filtering process using a generic process model to predict/propagate the form of the surface at the next time interval: this is indicated in FIG. 4.

The generic system model may be, for a gas cloud, a simple Brownian motion representation where diffusion is calculated by means of random walks of individual molecules. Alternatively, a more realistic model may be used such as the advection diffusion equation, as referred to below.

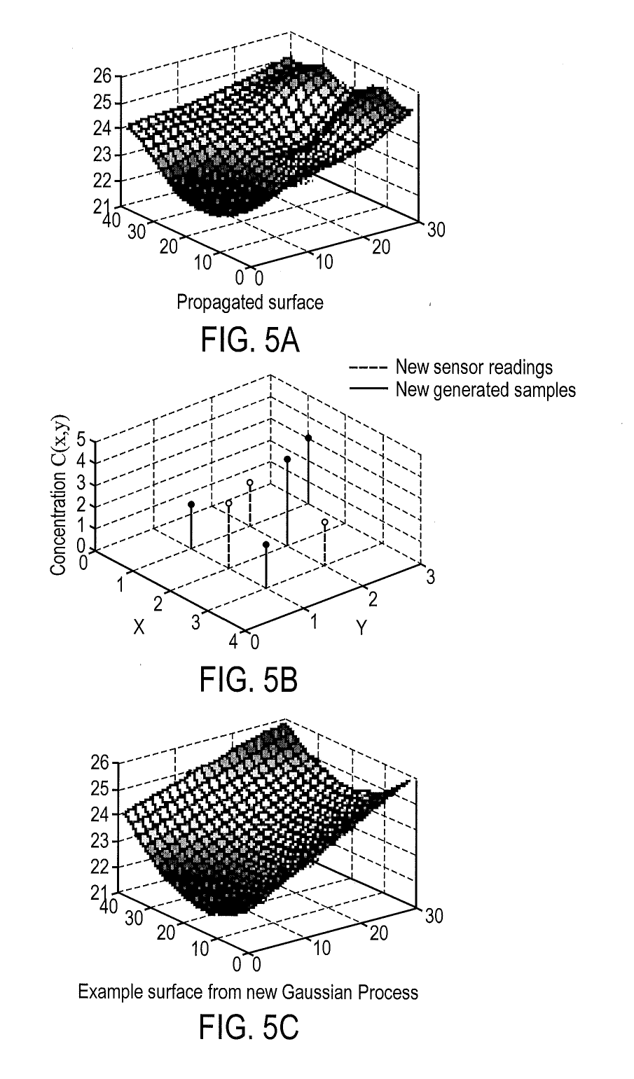

Referring to FIG. 5, a resampling takes place at the next sample interval, and the new sensor readings are employed to determine the likelihood of each function. As shown in FIG. 5b, extra points are sampled As shown in FIG. 5c, a new set of functions are generated to propagate forward to the next time interval.

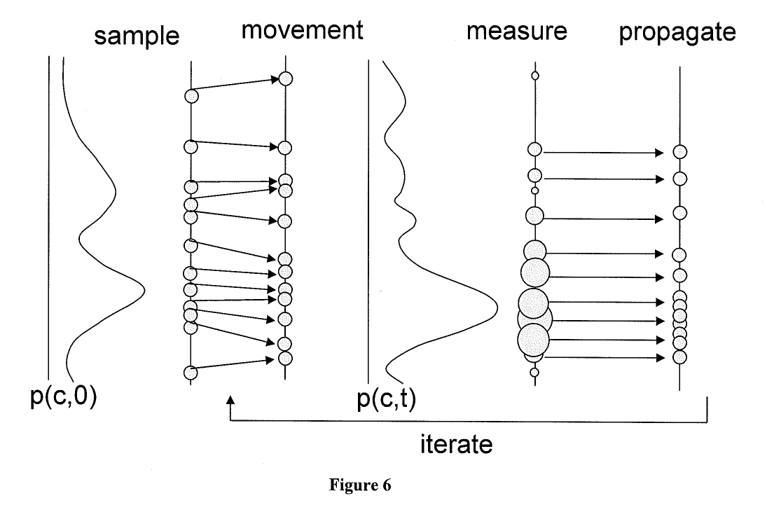

This process, indicated schematically in FIG. 6 in terms of the particle filtering process, is repeated, with an aim of determining an estimate as most likely to represent the actual gas concentration within the enclosed space.

In more mathematical terms, the Gaussian process may be represented as follows:
Gaussian Process is a collection of random variables, any finite subset of which have a joint Gaussian distribution.
Completely specified by it's mean m(x) and covariance functions k(x,x′)
Covariance functions are often stationary k(x,x′)=k(x−x′) and isotropic k(x,x′)=k(∥x−x′∥)

In mathematical terms, the processing of the sample functions of the Gaussian process takes place by determining covariance, in particular by determining elements of covariance matrices in known manner:

In the exemplary embodiment shown, the model employed in the prediction or propagation step is the advection-diffusion equation, as follows:

$$\frac{\partial c}{\partial t} = D [ \frac{{\partial }^{2} c}{\partial {x}^{2}} + \frac{{\partial }^{2} c}{\partial {y}^{2}} ] - v \frac{\partial c}{\partial x} - w \frac{\partial c}{\partial y}$$

Assume constant D, v and w.
Initial conditions: boundary conditions, current concentration of agent.
Solve using operator splitting method:
   Each component (diffusion In x,y, advection in x,y) solved separately.
   Result of previous component used as input to current component.

In this equation, D is the Diffusion constant, c the concentration, t time, x and y spatial coordinates, and v, w velocities.

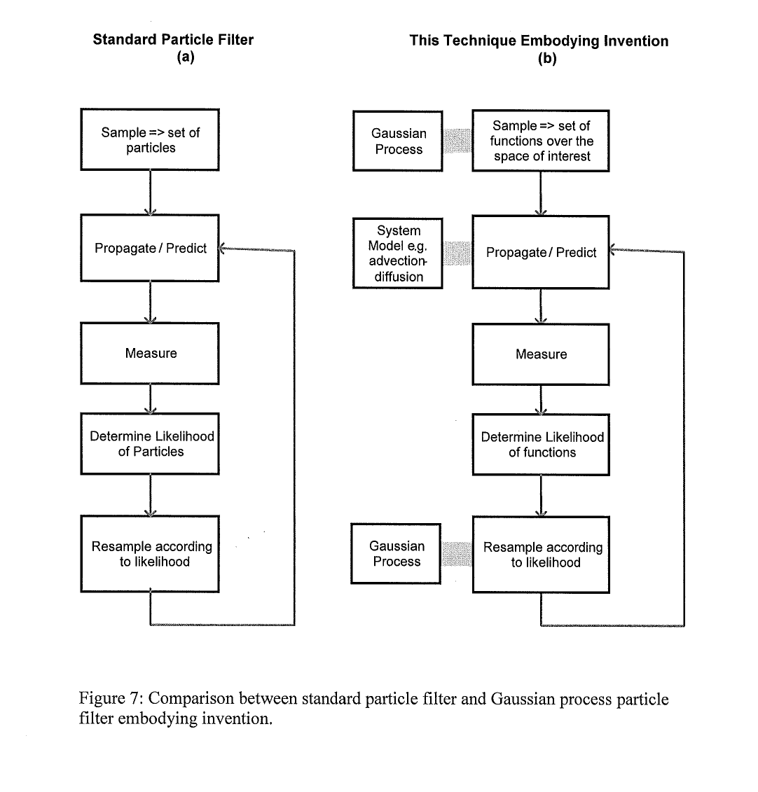

FIG. 7 draws a comparison between the standard particle filter process (FIG. 7(a)) and the process embodying the invention (FIG. 7(b)).

As shown in FIG. 7(a), the standard particle filter process comprises the following steps: 1. A set of particles is maintained that is candidate representatives of a system state. A weight is assigned to each particle, and an estimate of the state is obtained by the weighted sum of the particles (a non-analytic probability distribution function (pdf)). 2. A recursive operation is carried out that has two phases: prediction and update. 3. For prediction, at time the pdf is known at the previous time instant t=k−1. A system model is used to predict the state at time t=k. 4. For update, at time t=k, a measurement of the system becomes available, which is used to update the pdf that was calculated in the prediction phase. During update, the particles may be resampled to remove particles with small weight. 5. Return to step 3. above.

In contrast, the process embodying the invention as shown in FIG. 7(b) comprises the following steps: 1. A sample of (in the preferred instance, gas concentration) values is taken from sparsely located sensors. 2. A Gaussian process is then used to generate a distribution over functions that explains the set of sampled values. 3. Sample functions from this distribution are taken and propagated forward using a generic, physical propagation model. In the described embodiment, the advection-diffusion system model is used. Each of these surfaces is a particle in a in a particle filter, a method of discretely sampling through time a probability distribution. 4. In addition to the next reading from the sensors, additional synthetic point values are generated from the various propagated functions, weighted by their probability given the sensed values (Le. how close the propagated functions come to the next set of samples). 5. A new Gaussian process is created using the new sensed values and the synthetic extra points. This is used to generate a new distribution over functions and the process is repeated. In this way, advantageously, the statistical element of this invention compensates for unknowns like the complete physics of the domain.

Having thus described the present invention by reference to a preferred embodiment it is to be appreciated that the embodiment is in all respects exemplary and that modifications and variations are possible without departure from the scope of the invention.

1. A sensor array for detecting and estimating the progression of an item of interest, the sensor array comprising: a plurality of sensors, means for determining sensor readings at predetermined intervals,
Gaussian process means for determining at each interval a plurality of functions representing possible distributions of the item of interest,
system model means for predicting the value of each such function at a subsequent sampling instant, and
filter means for determining a likelihood value for each said function at the subsequent sampling instant, and for determining a revised plurality of functions with associated likelihood values.

2. An array as claimed in claim 1, wherein said system model means and said filter means form part of a particle filtering process means.

3. An array as claimed in claim 1, including display means for presenting to an operator a weighted average of said functions representing the most likely value of said item of interest at any particular instant.

4. An array as claimed in claim 1, wherein each function represents a distribution of gas within an enclosed space, and said system model means comprises an advection-diffusion equation.

5. In a sensor array for detecting and estimating the progression of an item of interest, the sensor array comprising a plurality of sensors and means for determining sensor reading at predetermined intervals, a method for estimating a distribution function for an item of interest, the method comprising the steps of:
determining at each interval a plurality of functions representing possible distributions of the item of interest by means of a Gaussian process,
predicting the progression of each such function at a subsequent sampling instant, using a system model for the item of interest,
determining a likelihood value for each function at the subsequent sampling instant, and determining a revised plurality of functions with associated likelihood values, and
repeating said predicting and determining steps.

6. A method according to claim 5, wherein each function represents a continuous field.

7. A method according to claim 6, wherein each function represents a distribution of gas within a confined space.

8. A method according to claim 7, wherein said system model comprises an advection diffusion equation.

9. A method according to claim 5, including at said subsequent sampling instant, determining weighted samples for each function, and determining said revised set of functions that are consistent with the weighted samples.

10. A method according to claim 9, including determining said weighted samples at positions of said sensors, and determining weighted samples at synthetic points spaced from the sensor positions.

11. A method according to claim 5, including presenting to an operator a weighted average of said functions representing the most likely value of said item of interest at any particular instant.

12. A computer program comprising program code means for performing the method steps of claim 5 when the program is run on a computer.

13. A computer program product comprising program code means stored on a computer readable medium for performing the method steps of claim 5 when the program is run on a computer.
